(19) United States
(12) Patent Application Publication
(10) Pub. No.: US 2011/0061078 A1
(43) Pub. Date: Mar. 10, 2011

(54) SYSTEM AND METHOD FOR CONTROLLING A PLURALITY OF ELECTRONIC DEVICES

(75) Inventor: Leigh M. Rothschild, Sunny Isles Beach, FL (US)

(73) Assignee: REAGAN INVENTIONS, LLC, Sunny Isles Beach, FL (US)

(21) Appl. No.: 12/944,929

(22) Filed: Nov. 12, 2010

Related U.S. Application Data
(63) Continuation-in-part of application No. 11/125,929, filed on May 10, 2005.

(51) Int. Cl. H04N 5/445

(52) U.S. Cl. 725/51

(57) ABSTRACT

An apparatus, a system and a method for controlling an operation of an electronic device is disclosed. The apparatus, system and method obviates the need of a user of a plurality of electronic devices, e.g., a television, digital video disc (DVD) player, VCR, etc, to keep track of and maintain a corresponding plurality of remote control devices. The apparatus, system and method provide a user with a graphic representation of the remote control device for each electronic appliance on a display controllable by a single, easy-to-use, intuitive transmitter. In addition, a memory for storing a widget is positioned within the electronic device or the apparatus. A microprocessor of the apparatus activates the widget and outputs the widget to a display. The widget and associated data is updatable and downloadable from a remote server without the need for the remote control device in which the widget is stored.

### PRIORITY

This application is a continuation-in-part application of U.S. patent application Ser. No. 11/125,929, filed May 10, 2005, entitled “SYSTEM AND METHOD FOR CONTROLLING A PLURALITY OF ELECTRONIC DEVICES”, the contents of which are incorporated by reference in their entirety.

### BACKGROUND

1. Field

The present disclosure relates generally to control systems for electronic devices or appliances, and more particularly, to systems and methods for remotely controlling a plurality of electronic devices through on-screen display graphic representations, communicating with a control device to program and setup these graphic representations through a global computer network, and interfacing with the control device through a small portable interface device.

2. Description of the Related Art

Various entertainment devices, e.g., televisions, digital video disc (DVD) players, VCRs, satellite receivers, etc., now litter the average home. These devices normally are operated through remote control (infrared or wireless) devices, with each entertainment device having its own remote control. Unified/universal remotes have attempted to end this ‘remote clutter’ but are limiting in design, functionality, and usefulness. Further, the unified/universal remotes are usually difficult to program and fail to have the look and feel of the original remote.

Therefore, a need exists for systems and methods for controlling a plurality of entertainment devices by a single, intuitive remote control device. Furthermore, a need exists for these systems and methods to function as an original remote control device without requiring programming of each device.

### SUMMARY

A system and method for controlling an operation of at least one electronic device or appliance are provided. The system and method of the present disclosure maintains the same look and feel and functionality of various original remotes supplied with entertainment devices, but renders them unnecessary. Further, the present disclosure details how entertainment devices may be controlled through one portable remote control transmitter that is very small and compact, or alternatively, controlled through one of the users pre-existing remotes. Moreover, this disclosure details how the remote transmitter communicates with an entertainment device (e.g. TV, Tivo™, stereo, DVD player, satellite receiver, cable control device, VCR, digital video recorder (DVR), etc), thorough a control device that is either external or internally located in the entertainment device. The control device, whether external or internal to the entertainment device, will communicate to the various entertainment devices by various communication methods including but not limited to wireless connectivity such as WiFi, Bluetooth, infrared, etc. and/or hardwire connectivity, such as Ethernet, USB cabling, Firewire, powerline communications, etc.

Various embodiments of the present disclosure may be used to access a widget, such as a graphical user interface widget, a desktop widget, a metawidget, a web widget, a widget application, a software widget, etc., where the widget enables the remote control functionality described herein. It is to be appreciated that a widget may be any single purpose stand alone application developed by various programming languages such as but not limited to Dynamic HyperText Markup Language (DHTML), JavaScript, Hypertext Preprocessor (PHP) scripting language, Adobe Flash, etc.

According to one aspect of the present disclosure, an apparatus for controlling an operation of at least one electronic device is providing including a memory for storing a widget, a graphic of a remote control device of the at least one electronic device and an associated control code for the remote control device; a microprocessor for controlling the widget and outputting the widget to a display, wherein the widget causes the microprocessor to retrieve the graphic of the remote control device upon the particular device being selected and outputs the retrieved graphic to a display; and a receiver for receiving positional information from a wireless remote transmitter for generating a pointer on the display relative to the graphic and for receiving a selection signal selecting a control function of the widget.

In one aspect, the apparatus includes a transmitter for transmitting a control code to the at least one electronic device, the control code associated to the selected control function.

In another aspect, the transmission module auto-detects the at least one electronic device and registers each at least one electronic device. Furthermore, the transmission module retrieves from the remote server the graphic of the remote control device of each registered electronic device and the associated control code for the remote control device.

According to another aspect, a method for controlling an operation of a plurality of electronic devices includes downloading a widget from a remote server, the widget remote control functionality for the plurality of electronic devices; selecting at least one device from the plurality of electronic devices; displaying a graphic of a remote control for the selected electronic device on a display; generating a pointer on the display relative to the graphic; selecting a function on the graphic; retrieving a control code corresponding to the function; and transmitting the control code to the selected device to control a function of the selected electronic device.

According to yet another aspect of the present disclosure, a television is provided including an input channel for receiving content to be displayed on a display of the television; a transmission module for coupling the apparatus to a remote server for downloading a widget and accessing data associated with the widget; a memory for storing the widget, a graphic of a remote control device of the at least one electronic device and an associated control code for the remote control device; a microprocessor for controlling the widget and outputting the widget to the display, wherein the widget causes the microprocessor to retrieve the graphic of the remote control device upon the particular device being selected and outputs the retrieved graphic to the display; and a receiver for receiving positional information from a wireless remote transmitter for generating a pointer on the display relative to the graphic and for receiving a selection signal selecting a control function of the widget.

In one aspect, the transmission module auto-detects the at least one electronic device and registers each at least one electronic device. Furthermore, the transmission module retrieves from the remote server the graphic of the remote control device of each registered electronic device and the associated control code for the remote control device.

In another aspect, the transmission module transmits the associated control code for the remote control device to the at least one registered electronic device via WiFi™ or Bluetooth™ or through pulse code signaling through existing electrical lines, i.e., via any known powerline carrier technology such as X10, Universal Power Bus (UPB), HomePlug Powerline Alliance, etc.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a diagram of a system for controlling at least one electronic device in accordance with an embodiment of the present disclosure;

FIG. 2 is a schematic diagram of a controller in accordance with an embodiment of the present disclosure;

FIG. 3 is a schematic diagram of a transmitter in accordance with an embodiment of the present disclosure;

FIG. 4 is a flowchart illustrating a method for programming the controller;

FIG. 5 is a flowchart illustrating a method for controlling an operation of at least one electronic device in accordance with the present disclosure;

FIG. 6 illustrates several display views for describing various operations of the system of the present disclosure;

FIG. 7 illustrates an electronic device that may store and/or access a widget and may be used with the controller in an embodiment of the present disclosure; and

FIG. 8 illustrates a flowchart illustrating a method for obtaining and utilizing a widget in an embodiment of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

A system and method for controlling an operation of at least one electronic device or appliance is provided. The system and method of the present disclosure obviates the need of a user of a plurality of electronic devices, e.g., a television, digital video disc (DVD) player, digital video recorder (DVR), VCR, etc, to keep track of and maintain a corresponding plurality of remote control devices. The system and method provide a user with a graphic representation of the remote control device for each electronic appliance on a display controllable by a single, easy-to-use, portable, intuitive transmitter. The graphic representations and associated control codes for the plurality of electronic appliances are downloadable via a global computer network, e.g., the Internet. In accordance with the present disclosure, a user can access all of the functions of each of the plurality of electronic appliances with a single remote transmitter without having to manually program the transmitter for each electronic appliance.

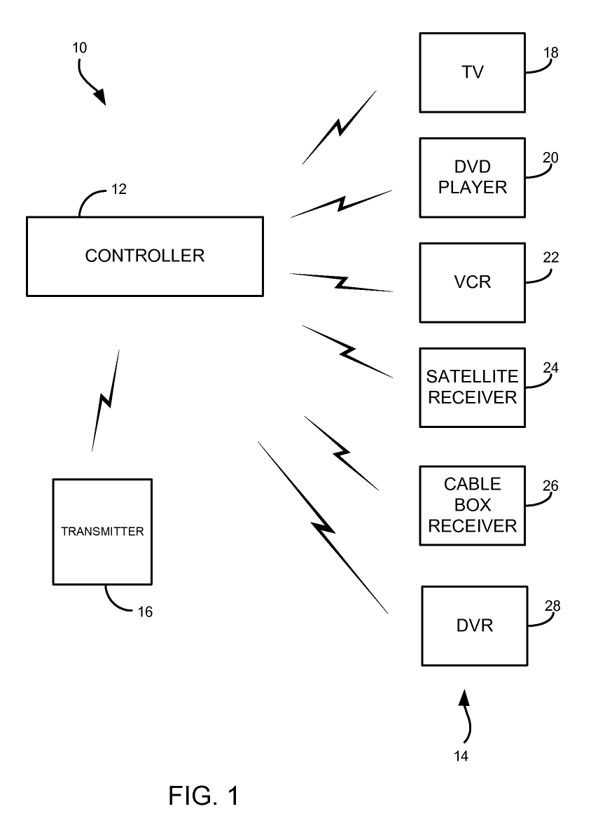

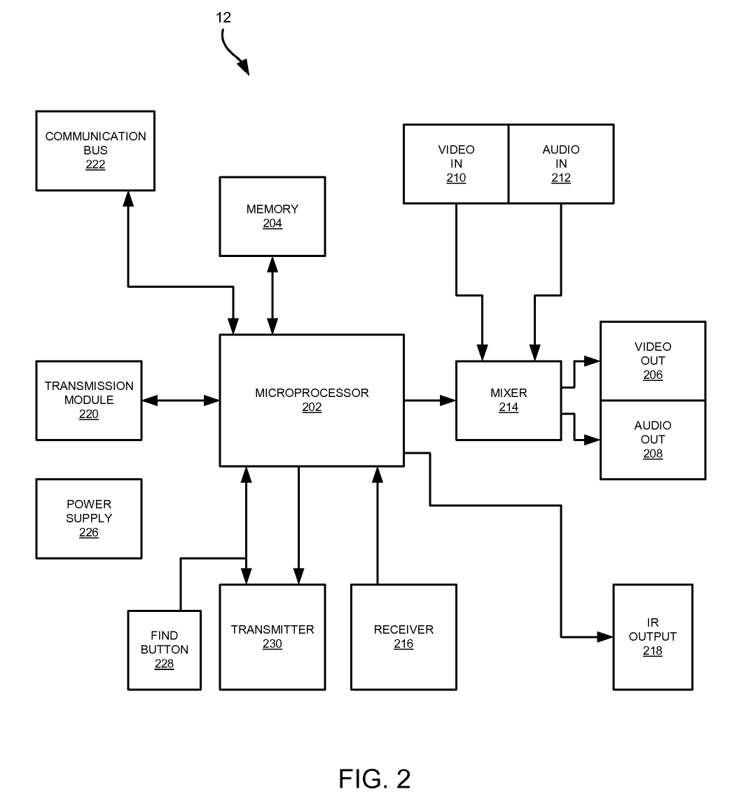

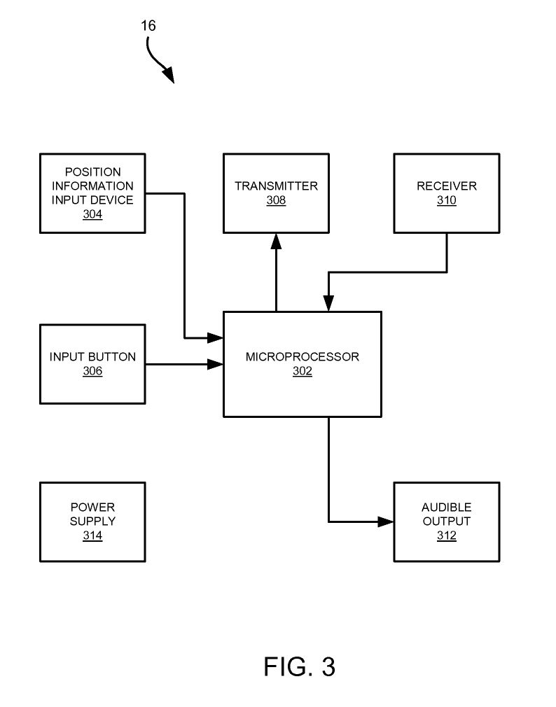

Referring to FIG. 1, a system for controlling an operation of at least one of a plurality of electronic devices or appliances is generally represented by the numeral 10. The system 10 includes a controller 12 for generating a graphic representation of at least one remote control device to be displayed on a display device, for receiving an input command relating to the at least one graphic and for generating and transmitting a control signal in response to the input command to at least one of a plurality of electronic devices 14. The electronic devices may include any known electronic appliance or component commonly employed in a home entertainment system, e.g., a television 18, a digital video disc (DVD) player 20, a VCR 22, a satellite receiver 24, a cable box receiver 26, digital video recorder (DVR) 28, etc. The electronic devices may further include lighting systems and computer systems. The system 10 further includes a remote control transmitter 16 for generating and transmitting command signals to the controller 12. Both the controller 12 and transmitter 16 will be described in more detail below with reference to FIGS. 2 and 3.

The controller 12 includes a microprocessor 202 for controlling the overall operations of the controller 12. A memory 204 is coupled to the microprocessor 202 and stores a plurality of graphic representations and command codes associated with a particular electronic appliance. The graphic representation is an image of the remote control device associated with a particular electronic appliance. The command codes that would normally emanate from the remote control are stored along with the graphic and will be employed to control the electronic appliance as will be described in more detail below.

A video output port 206 for outputting a video signal to a display, e.g., a television, CRT monitor, etc., and an audio output port 208 for outputting an audio signal are provided. The video output port 206 may be any known output interface including but not limited to a composite output, S-video, video graphics array (VGA), digital video interface (DVI), High-Definition Multimedia Interface (HDMI), etc. The video output port 206 is coupled to the microprocessor 202 and receives the graphic of the remote control device and transmits the graphic to a display device. The controller 12 further includes a video input 210 and audio input 212 that are coupled to the video output port 206 and audio output port 208 via a mixer 214. In one state, the mixer 214 will receive signals from the video input 210 and audio input 212 and pass them straight through to the video output port 206 and audio output port 208. Here, the video input 210 and audio input 212 are basically pass-through jacks that mirror the original jacks, or ports, on the display device to allow a user to utilize the input jacks or ports of the display device even when the controller 12 is connected thereto. In another state, the mixer 214 will superimpose a graphic of a remote control device onto the video signal received from the video input 210. The superimposed graphic may consume the whole screen of the display device or may act as a pop-up on a variable portion of the viewable area of the display.

A receiver 216 is provided for receiving positional information from the transmitter 16 and transmitting the positional information to the microprocessor 202. Once the graphic is displayed on the display, the transmitter 16 will act as a cursor control device to align a pointer over a specific function button on the remote control graphic. The receiver 216 will determine the cursor position information and send it to the microprocessor 202 which will generate a pointer in the relative position on the graphic. The receiver 216 may be a photosensor for receiving infrared signals or may be a conventional receiver operating under any of the various known wireless protocols including but not limited to Bluetooth™ interconnectivity, radio transmission connectivity including computer digital signal broadcasting and reception commonly referred to as Wi-Fi or 802.11x (where x denotes the type of transmission), or any other type of communication protocol or system currently existing or to be developed for wirelessly transmitting data.

Once a control function has been determined by the microprocessor 202 by determining the pointer location on the remote control graphic, the microprocessor will retrieve the proper control code from the memory 204 and transmit the control code to the appropriate electronic device via an infrared (IR) blaster 218, as is known in the art. An exemplary IR blaster is model IR-200L commercially available from ACTiSYS Corp. of Fremont, Calif. The infrared blaster 218 will transmit the control code via a series of infrared light pulses as would the original remote control device associated with the particular electronic appliance. The IR blaster 218 preferably is integral within a housing of the controller 12 but may located remotely from the controller to be in close proximity to the IR receiver of the particular electronic appliance. For example, the IR blaster 218 may be incorporated into any one of the electronic devices 14 shown in FIG. 1. In one example, the controller may be integrated into a display device, such as a television, where the IR blaster 218 may be disposed on a surface of the display device or the display device may have an IR output port for extending the IR output to other devices or locations via cabling.

The controller 12 further includes a transmission module 220 for coupling the controller 12 to a global computer network, e.g., the Internet, to enable data transmission between the controller 12 and other computing devices, e.g., a web server. The transmission module 220 may be but not limited to a network interface card (NIC), e.g., an Ethernet card, a WI-FI card, a Bluetooth™ transceiver, an analog/digital modem or any other known data transmission device. As will be described in more detail below, the controller 12 will access a web server during initial setup and programming and to retrieve further graphics and codes as new remote control devices are added to the system. A user will go to an established website on the Internet to register the controller 12 and existing remote control device models. A download then occurs to the controller 12 of images and bitmap charts of the remote controls selected and also the code sets for the remote control devices to be utilized with the IR blaster 218. By example if a Phillips™ remote for a VCR is registered, an image of that remote and bit map/programming would be downloaded and stored in memory in the controller 12. The controller 12 would then interpret when the transmitter 16 aligns points on the image of the remote, and subsequently, specific IR signals would be emitted from the IR blaster 218 to control the Phillips™ VCR.

The controller also includes a communication bus module 222 for coupling a plurality of controllers 12 together via a daisy-chained hardwire connection. By locating several controllers throughout a location, e.g., a home, the controllers can be located near electronic appliances located in various locations allowing a user to have control over the various electronic appliances from any controller location. The communication bus module 222 may additionally couple a plurality of infrared repeaters to the controller 12 for controlling electronic devices located remotely from the controller 12.

Optionally, the controller 12 may include a find button 228, e.g., a momentary switch, which when depressed will initiate a locate signal to the remote control transmitter 16. The find button 228 may be directly coupled to a transmitter 230 or to the transmitter 230 via the microprocessor 202. The operation of the find button and locate signal will be described in more detail below in relation to the remote control transmitter 16.

A power supply 226 is coupled to at least the above-mentioned components for supplying power to each component. Preferably, the power supply 226 is externally powered by AC current. The power supply 226 preferably also includes a battery back-up for retaining the contents of memory 204 in the event of a power supply failure.

It is to be understood that the present disclosure may be implemented in various forms of hardware, software, firmware, special purpose processors, or a combination thereof. A system bus couples the various components shown in FIG. 2 and may be any of several types of bus structures including a memory bus or memory controller, a peripheral bus, and a local bus using any of a variety of bus architectures. The system also includes an operating system and micro instruction code. The various processes and functions described herein may either be part of the micro instruction code or part of an application program (or a combination thereof) which is executed via the operating system.

It is to be further understood that because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

In a preferred embodiment of the present disclosure, the controller or controller components would be hardwired and resident in either a television, or another ancillary device hooked to a television or entertainment device such as a cable television control device, satellite television control device, Tivo™ or other type of personal (digital) recording device, DVD player, VCR, personal media computer, or any other type of device that is coupled to a display monitor.

Referring to FIG. 3, the remote control transmitter 16 of the present disclosure is illustrated. The transmitter 16 includes a microprocessor 302 for controlling the overall operations of the transmitter 16, receiving input information and generating command signals to be transmitted to the controller 12. The transmitter 16 includes a positional information input device 304, e.g., a touch pad, for generating a relative position information signal which will be transmitted to the controller 12. The positional information input device 304 will control the pointer or cursor on the display for selecting a function on the graphic of the selected remote control device. The transmitter 16 also includes at least one button 306 for confirming selection of a control function on the graphic of the remote control.

The microprocessor 302 will receive the input signals generated by positional information input device 304 and the at least one button 306 and will generating a command signal that will be transmitted to the controller 12 by transmitter 308. The transmitter 308 will operate under a compatible protocol with the receiver 216 of the controller 12.

The transmitter 16 will further include a receiver 310 for receiving data from the controller 12. Preferably, the receiver 310 will receive a locate signal from the controller 12 and transmit the received locate signal to the microprocessor 302 which will in turn generate a signal to activate an audible output 312, e.g., a speaker, buzzer, tone generator, etc. In this manner, upon depressing the find button 228 on the controller 12, the transmitter 16 will produce an audible sound facilitating a user locating the transmitter 16.

Furthermore, a power supply 314 is coupled to at least the above-mentioned components for supplying power to each component of the remote controller transmitter 16.

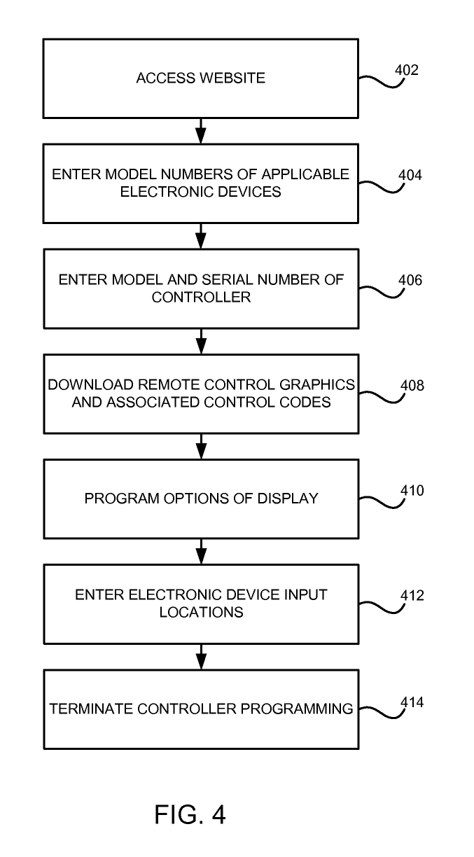

A method for programming the controller 12 will now be described with reference to FIG. 4. Initially, in step 402, a user goes to a designated website. The user will be prompted to enter the model numbers of their applicable devices, e.g., television, DVD player, etc. in registration form (step 404). Then, in step 406, the user will be prompted to enter the model and serial number of controller 12 in their possession and to indicate a network connection of the controller 12 (and type of connection, e.g. Bluetooth™, wired, WiFi, etc). A web server then contacts the controller 12 through a local network connection and sets up the controller 12, where the microprocessor 202 is programmed with executable instructions, and software is now resident to display various remote control graphics (step 408). The control codes associated with each electronic device and/or remote control is also downloaded and stored in memory 204.

Optionally, the user may also designate any existing remote control as the remote to replace the transmitter 16 by entering at the website the model number and manufacturer of the existing remote control, and the controller 12 will then accept IR input from the designated remote control device.

In step 410, the user then tells controller 12 during setup, either through the global computer network or alternatively at the controller 12 itself, how the remote control graphic is to be displayed during use. For example, the user will select a color of TV background, whether the graphic is a full overlay or see through overlay, a position for the pop-up graphic to appear, and size of pop-up, time for overlay to appear, tactile information (such as occurs during computer mouse setup), order for remotes to be displayed in, whether graphic remotes appear, or just keyboard remote choices. Following this step, the user may check to see if all remote controls are displayed on the screen.

Next, in step 412, the user also tells the controller 12 where each electronic device or appliance is located on the display/TV inputs, e.g. DVD is video input number one, VCR is video input 2, high def sat is dvi-1, cable is ant A, Tivo™ is input-2, etc. At this point, the controller 12 is programmed and the setup procedure is terminated (step 414). The user may now employ the single transmitter 16 to control the plurality of electronic devices.

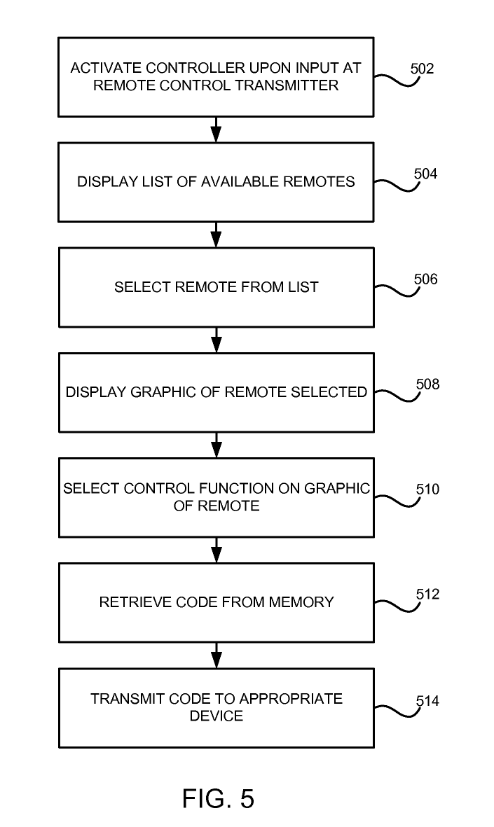

Referring to FIG. 5, a method for controlling an operation of at least one electronic device in accordance with the present disclosure is illustrated. Initially, in step 502, the user will activate the controller 12 upon any input at the remote control transmitter 16, e.g., clicking one of the buttons 306 or touching the touch pad 304. Once the user activates the controller 12, a pop up will appear, either replacing an image on the display or overlaying the image on the display, listing the remotes and/or electronic devices that have been programmed into the system (step 504). The user can control the size of the image and determine whether the image is to be an overlay or to be positioned on a portion of the display. In step 506, the user can scroll down with the position information input device 304 on the remote transmitter 16 to pick the remote or device they want. Next, a remote graphic or picture of the remote selected appears (step 508).

Once the graphic of the remote is displayed, the user can then operate the selected remote through the transmitter 16 with scroll controls and button controls (step 510). Using the touch pad, the user aligns a pointer or cursor on a control button of the displayed graphic, e.g., a play button, and selects the functions with a click of the at least one button 306. The controller 12 correlates the position that the user has selected on the remote graphic, and using standard programming instructions and processing power of the microprocessor 202, the controller 12 retrieves the appropriate control code from memory 204 (step 512). Then, the controller 12 orders the IR instruction code for the position selected on the remote control to be emitted (blasted) from the IR blaster 218 to the entertainment devices. Entertainment devices are thus controlled with a single small remote transmitter 12 (or the users existing remote if selected) and all remote control images can be resident on screen whenever they are needed. The remote transmitter can control any function available on the selected remote, e.g., change a channel, adjust volume, play a DVD, fast forward a video tape, etc.

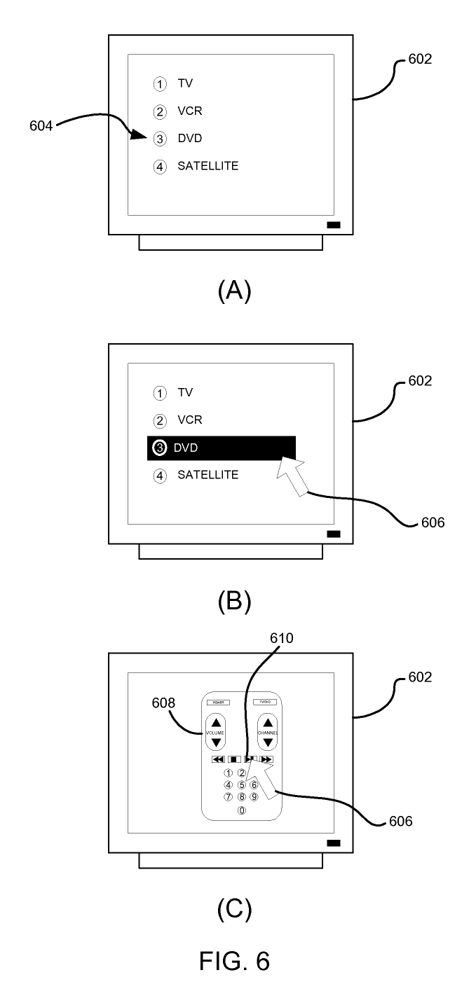

To further illustrate the operations of the system 10 of the present disclosure, FIG. 6 shows several display views generated by the system 10. Initially, the user signals the controller 12 to display a list 604 of remotes on a display 602, e.g., a television (see FIG. 6A). Using the touch pad on the transmitter, the user moves the pointer 606 to select the DVD player (see FIG. 6B). Then, the DVD player remote appears and, at the same time, the controller 12 transmits a signal via the IR blaster 218 to switch TV input to the input that the DVD player is located on, which it knows from user setup described above. The graphic 608 of the selected remote remains overlaid on the screen of the display 602 as shown in FIG. 6A. The user may then select “DVD play” on the remote graphic 608 by scrolling and then clicking on the play button 610. The controller then blasts the DVD player to start a play sequence. The user may then watch the movie and remote overlay disappears after a predetermined, user adjustable time. At a later time, the user may click the transmitter 16 and the last graphic (e.g., DVD remote) appears. The user may then scroll to and then click the pause button and the controller 12 blasts the player DVD to pause. The user may then click another button of the at least one button 306 and the list of all remotes in the system appears (FIG. 6A). The user aligns and clicks TV, and a graphic of the TV's remote pops up on screen. The user clicks the power button on graphic of the TV remote and the TV shuts down.

In another embodiment of the present disclosure, a user can network at least one other controller 12, which is Ethernet/Bluetooth/Wi-Fi connected, to a remote display/television location. The output of the display/television would be connected to the input on the controller. The user may then from a main location also control remotely located devices such as a Tivo™ control device, etc., providing said devices have a video output. This video output would be streamed from the remote location controller to the main controller on the local computer network (either WiFi or Ethernet wiring, or Bluetooth, etc.) and the user would then see this streamed content output from the main controller video output signal which is input to the local display device.

In a further embodiment, the controller is resident in an entertainment device and, using a local or global computer network, communicates (via Wi-Fi/Bluetooth, etc. or wired) the status of the device to a user. The status information includes but is not limited to: power on/power off, audio volume, channel indication, signal frequency indication, internal temperature, power consumption, storage space, e.g., memory, for a resident digital storage device both free and utilized, sharpness of image, brightness of image, color of image, convergence aspects of display tube, etc. This information may be viewable by the user at a website or may be e-mailed to the user. Alternatively, a manufacturer of the entertainment device may receive the information and contact the user if they detect a possible malfunction with the device. It is to be appreciated that the integrated entertainment device will include the IR output 218, wherein the controller 12 orders the IR instruction code (e.g., play, pause, fast forward, fast reverse, chapter skip, volume up down and mute, channel selection, record, information, programming functions, etc.) for the position selected on the remote control to be emitted (blasted) from the IR blaster 218 to the various other entertainment devices. In a network connected embodiment, the transmission module 220 of the integrated entertainment device will transmit appropriate control messages via hardwire or wireless connections to corresponding transmission modules disposed in each of the electronic devices 14, e.g., a DVD player, VCR, DVR, etc. It is to be appreciated that the control messages may be routed through a local area network (LAN) or through the Internet. Further, in another embodiment, the transmission module 220 of the integrated entertainment device transmits the associated control code for the remote control device to the other devices through pulse code signaling through existing electrical lines, i.e., via any known powerline carrier technology such as X10, Universal Power Bus (UPB), HomePlug Powerline Alliance, etc.

A system and method for controlling an operation of at least one electronic device, e.g., an entertainment device, has been described. The system and method of the present disclosure eliminates the need for a multitude of remote controls, simplifies the programming of a plurality of remotes into a single device, e.g., transmitter 16, is totally scalable and upgradeable, and the remote control transmitter 16 has a very small form factor.

In an embodiment, the above-described embodiments may be used to access a widget, such as a graphical user interface widget, a desktop widget, a metawidget, a web widget, a widget application, a software widget, etc., where the widget enables the remote control functionality described above. It is to be appreciated that a widget may be any single purpose stand alone application developed by various programming languages such as but not limited to Dynamic HyperText Markup Language (DHTML), JavaScript, Hypertext Preprocessor (PHP) scripting language, Adobe Flash, etc.

The widget may access data or information on the controller 12, one of the electronic devices 14, a remote server, a remote database, a website or other source of data or information. The widget may access the data or the information automatically at predetermined time intervals or at a request of the user. For example, the widget may continuously operate such that the widget continually accesses the information or the data. Alternatively, the widget may be activated upon request of the user, and upon activation access the data or the information once, at predetermined intervals, or continuously.

The data or the information may comprise a software application on one of the electronic devices 14 and/or the controller 12. As another example in addition to the remote control functionality described above, the widget may display information related to an advertisement, financial information, weather, sports, entertainment, food, travel, commerce, a personal or business calendar, date and time, or any data or information available on the Internet. In an embodiment, the widget may be created by a third party, such as a social networking company, media content provider, an information or data provider or other party providing data or information desirable by a user of the electronic device 14. The data or the information may relate to a property or status of the controller 12 or one of the electronic devices 14, such as battery life, internal temperature, external temperature, audio volume, channel indication, display characteristics, status of Internet connection, memory levels, operating speeds or the like. The data or the information may be customized by the user via the widget.

The widget may have and/or may output a user interface with one or more control functions related to the widget. For example, the control functions may change a portion of the data and/or the information being shown by the widget, may request that the data and/or the information associated with the widget be updated, may control an attribute of the widget, such as its size, shape, brightness, update frequency, or position on the display. In an embodiment, the user interface may comprise a menu and a plurality of buttons or other controls to permit ease in selecting the functions and controls of the widget. For example, the one or more buttons may perform functions related to the widget, such as updating data related to the widget, upgrading the widget itself, changing a setting related to the widget, and display a portion of data related to the widget.

Turning again to FIG. 2, the memory 204 of the controller 12 may store the widget. The microprocessor 202 may access the widget and the associated data and information, e.g., at least one remote control graphic and its associated control codes. The controller 12 may output and/or may display the widget on one of the electronic devices 14, such as via the mixer 214 and/or the video out 206. In such an embodiment, the remote control transmitter 16 may transmit a control signal to the controller 12 to access, control and/or interact with the widget. The controller 12 may receive the signal and/or the positional information via the receiver 216. For example, the remote transmitter 16 may transmit a control signal and/or positional information to the controller 12. Based on the control signal and/or the positional information, the widget may be accessed, activated and/or manipulated. For example, upon depressing a predetermined button on the remote transmitter 16, a single or a plurality of widgets may be presented to the user. The user may then scroll through the plurality of widgets to select a desired widget, e.g., a remote control widget. The remote control widget will then display either a default preselected remote control graphic or a plurality of selectable remote control graphics. Upon selecting a particular remote control graphic, e.g., a remote control graphic for a DVD player, the user can control an associated DVD player via the displayed remote control as described above.

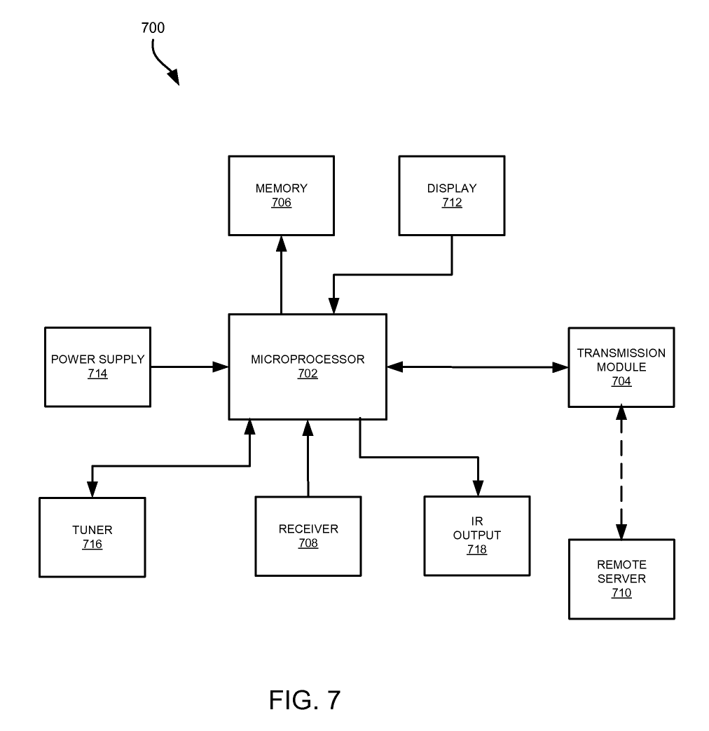

The controller 12 may access and/or may obtain, the widget, the data, and the information from a remote server 710, as shown in FIG. 7. The controller 12 may access the remote server 710 via the transmission module 220. The controller 12 and the remote server 710 may continuously or periodically communicate as set forth above.

It is to be appreciated that the widget may be provided by a manufacturer of a particular device, e.g., a television, or from third party developers. In certain embodiments, the widget may be preloaded in a memory of the particular device by the manufacturer of the device.

FIG. 7 illustrates another embodiment of the present disclosure where the widget may be stored and/or accessed by one of the electronic devices 700. The electronic device 700, for example, may be one of the electronic devices 14 such as a television. The electronic device 700 may have a memory 706 for storing the information, the data and/or the widget. The memory 706 may store information or data as described above with respect to the memory 204 of the controller 12. A microprocessor 702 may access the data, the information and/or the widget. The electronic device 700 may display the widget and/or the information and the data via the display 712. The electronic device 700 may be powered by the power supply 714. A transmission module 704 of the electronic device 700 may communicate with a remote server 710 or other device similar to the transmission module 220 of the controller 12. The widget, the data and the information may be stored on the memory 706 and/or the remote server 710. In an embodiment, the widget may be stored on the memory 706, and the associated data and the information may be stored on the remote server 710 and accessed via the transmission module 704. As the data and/or the information associated with the widget changes on the remote server 710, the transmission module 704 may access the remote server 710 and store the updated information and data on the memory 706 and/or display the data and the information on the display 712. Accordingly, the electronic device 700 may store the widget and the data and information locally on the memory 706 or remotely on the remote server 710 and/or a combination of the memory 706 and the remote server 710.

The remote server 710 may be any device storing data or information located remotely from the electronic device 700, such as a website, a web server, a remote database, a digital recording device, a music server, a streaming video source, or a memory of another electronic device. The electronic device 700 may be controlled by the controller 12 as described above with respect to the electronic devices 14. It should be understood that any one or more of the electronic devices 14 may store the widget, which may be displayed by any one of the electronic devices 14.

In one embodiment, the electronic device 700 may be embodied as an Internet connected television, where transmission module 704 connects the television to the Internet and tuner 716 receives a selectable channel of programming or broadcast content. It is to be appreciated that the Internet connected television may include all, a portion of or more than the components shown and described in relation to FIG. 2. Upon depressing a predetermined button on the remote transmitter 16, a single or a plurality of widgets may be presented to the user on the display 712 of the television 700. The user may then scroll through the plurality of widgets to select a desired widget, e.g., a remote control widget. The remote control widget will then display either a default preselected remote control graphic or a plurality of selectable remote control graphics. Upon selecting a particular remote control graphic, the user can control an associated electronic device via the displayed remote control as described above.

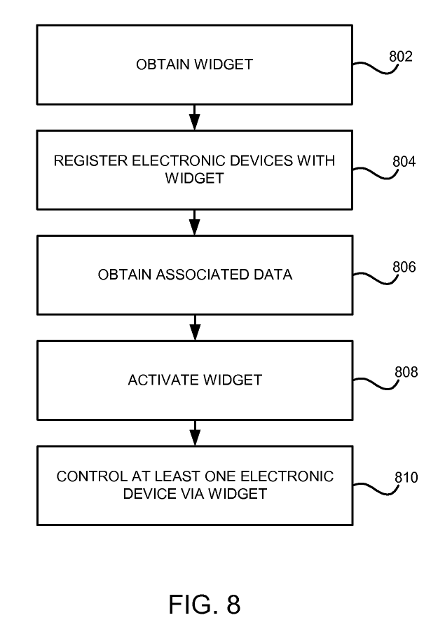

FIG. 8 illustrates a flowchart 800 that describes an embodiment of the disclosure. As shown in step 802, the widget may be obtained. The widget may be pre-stored on the controller 12 and/or one of the electronic devices 14, 700. The widget or an updated version of the widget may be obtained or accessed via a transmission module 220, 702 of the controller 12 or the electronic device 700, respectively. For example, in the embodiment of an Internet connected television, the transmission module 704 will contact the remote server 710 and download a requested widget or a listing of newly available widgets. The user may select to download a predetermined widget, e.g., the remote control widget, or browse through the listing of available widgets to find the widget of interest. Once selected, the widget is downloaded and stored for future use in the memory 204 of the controller or memory 706 of device 700. The widget may be updated continuously, at a predetermined time or time increments as requested by the user, and/or when an updated widget becomes available from the remote server 710.

In one embodiment, upon depressing a predetermined button on the remote transmitter 16, a single or a plurality of widgets may be presented to the user on the screen of the television. The user may then scroll through the plurality of widgets to select a desired widget, e.g., a remote control widget. Upon initial use of the widget, each of the plurality of electronic device 14 is registered with the widget, at step 804. In one embodiment, the registration process is as described above in relation to FIG. 4, where a user selects each electronic device via a user interface and manually enters among other things model numbers of the electronic device, model and serial numbers of the remote controls, etc. In another embodiment, the electronic device 700 auto-detects each of the electronic device 14 via a hardwire or wireless connection. In one embodiment, the device 700 and each of the devices 14 reside on the same network via cabling to a router, hub, switch or the like. In the wireless embodiment, the device 700 and each of the devices 14 will have a wireless transmission module such as a WiFi™ or Bluetooth™ module. During the registration process of step 804, the controller 12 or device 700 will determine the electronic devices 14 on the network. The controller 12 or device 700 will then communicate to each electronic device 14 to retrieve the device type, the model number for the device, the serial number for the device, etc.

The widget will then use this retrieved information to obtain data and/or information associated to each of the registered devices, in step 806. The data and/or the information associated with the widget may be at least one graphic associated with the selected remote control and the associated control codes that would emit from the selected remote control. The data and/or the information may be stored on the memory 706 of the electronic device 700, the memory 204 of the controller 12 and/or the remote server 710.

In step 808, the user will activate the widget upon any input at the remote control transmitter 16, e.g., clicking one of the buttons 306 or touching the touch pad 304. Once the user activates the widget, a pop up will appear, either replacing an image on the display or overlaying the image on the display, listing the remotes and/or electronic devices that have been programmed into the system. The user can pick the remote or device they want and the remote graphic or picture of the remote selected appears.

Once the graphic of the remote is displayed, the user can then operate the selected remote through the transmitter 16 with scroll controls and button controls (step 810), as described above. For example, using the touch pad, the user aligns a pointer or cursor on a control button of the displayed graphic, e.g., a play button, and selects the functions with a click of the at least one button 306. The controller 12 or electronic device 700 correlates the position that the user has selected on the remote graphic, and using standard programming instructions and processing power of the microprocessor 202, 702, the controller 12 or electronic device 700 retrieves the appropriate control code from memory 204, 706. Then, the controller 12 or device 700 orders the IR instruction code for the position selected on the remote control to be emitted (blasted) from the IR blaster 218, 718 to the entertainment devices. In the network connected embodiment, the transmission module 704 will transmit appropriate control messages via hardwire or wireless connections to corresponding transmission modules disposed in each of the electronic devices 14, e.g., a DVD player, VCR, DVR, etc.

Entertainment devices 14 are thus controlled with a single small remote transmitter 16 (or the users existing remote if selected) and all remote control images can be resident on screen whenever they are needed. The remote transmitter can control any function available on the selected remote, e.g., change a channel, adjust volume, provide status information on a device, play a DVD, fast forward a video tape, etc. It is to be appreciated that the remote transmitter can be as simple as a wireless pointer with a single button to activate or make selections. In other embodiments, the remote transmitter may be a hand-held angle sensing controller, e.g., a device including a gyroscope, accelerometer, etc, which senses user movements and translated those movements into input functions. For example, the user may use such a hand-held angle sensing controller to highlight a selection, e.g., a button on a remote control displayed on the screen, and then via a predetermined motion (e.g., making a check mark motion in the air) select or activate the highlighted selection.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. An apparatus for controlling an operation of at least one electronic device, the apparatus comprising:
a memory for storing a widget, a graphic of a remote control device of the at least one electronic device and an associated control code for the remote control device;
a microprocessor for controlling the widget and outputting the widget to a display, wherein the widget causes the microprocessor to retrieve the graphic of the remote control device upon the particular device being selected and outputs the retrieved graphic to a display; and
a receiver for receiving positional information from a wireless remote transmitter for generating a pointer on the display relative to the graphic and for receiving a selection signal selecting a control function of the widget.

2. The apparatus of claim 1, further comprising a transmitter for transmitting a control code to the at least one electronic device, the control code associated to the selected control function.

3. The apparatus of claim 1, further comprising a transmission module for coupling the apparatus to a remote server for downloading the widget.

4. The apparatus of claim 3, wherein the transmission module auto-detects the at least one electronic device and registers each at least one electronic device.

5. The apparatus of claim 4, wherein the transmission module retrieves from the remote server the graphic of the remote control device of each registered electronic device and the associated control code for the remote control device.

6. The apparatus of claim 5, wherein the transmission module communicates with a remote server at a predetermined time and retrieves data related to the widget.

7. The apparatus of claim 5, wherein the transmission module transmits the associated control code for the remote control device to the at least one electronic device via the Internet.

8. The apparatus of claim 5, wherein the transmission module transmits the associated control code for the remote control device to the at least one registered electronic device via powerline carrier transmission.

9. The apparatus of claim 1, further comprising a video out for displaying the widget on a display of an electronic device.

10. The apparatus of claim 1, further comprising a display for displaying the widget.

11. The apparatus of claim 1, wherein the graphic of the remote control device is a graphic of a remote control device original to or manufactured by a manufacturer of the particular electronic device.

12. The apparatus of claim 1, further comprising a communication bus module for coupling at least one additional apparatus for controlling at least one second electronic device located remotely.

13. A method for controlling an operation of a plurality of electronic devices, the method comprising the steps of:
downloading a widget from a remote server, the widget remote control functionality for the plurality of electronic devices;
selecting at least one device from the plurality of electronic devices;
displaying a graphic of a remote control for the selected electronic device on a display;
generating a pointer on the display relative to the graphic;
selecting a function on the graphic;
retrieving a control code corresponding to the function; and
transmitting the control code to the selected device to control a function of the selected electronic device.

14. The method of claim 13, further comprising auto-detecting each device of the plurality of electronic devices and registering each electronic device.

15. The method of claim 14, further comprising retrieving from the remote server the graphic of the remote control device of each registered electronic device and the associated control code for the remote control device.

16. The method of claim 15, further comprising communicating with the remote server at a predetermined time and to retrieve updated data related to the widget.

17. A television comprising:
an input channel for receiving content to be displayed on a display of the television;
a transmission module for coupling the apparatus to a remote server for downloading a widget and accessing data associated with the widget;
a memory for storing the widget, a graphic of a remote control device of the at least one electronic device and an associated control code for the remote control device;
a microprocessor for controlling the widget and outputting the widget to the display, wherein the widget causes the microprocessor to retrieve the graphic of the remote control device upon the particular device being selected and outputs the retrieved graphic to the display; and
a receiver for receiving positional information from a wireless remote transmitter for generating a pointer on the display relative to the graphic and for receiving a selection signal selecting a control function of the widget.

18. The television of claim 17, further comprising an infrared transmitter for transmitting a control code to the at least one electronic device, the control code associated to the selected control function.

19. The television of claim 17, wherein the transmission module auto-detects the at least one electronic device and registers each at least one electronic device.

20. The television of claim 19, wherein the transmission module retrieves from the remote server the graphic of the remote control device of each registered electronic device and the associated control code for the remote control device.

21. The television of claim 20, wherein the transmission module transmits the associated control code for the remote control device to the at least one registered electronic device via WiFi or through the Internet.

22. The television of claim 20, wherein the transmission module transmits the associated control code for the remote control device to the at least one registered electronic device via Bluetooth.
